(19) United States
(12) Patent Application Publication
(10) Pub. No.: US 2016/0189217 A1
(43) Pub. Date: Jun. 30, 2016

(54) TARGETING USING HISTORICAL DATA

(71) Applicant: Yahoo! Inc., Sunnyvale, CA (US)

(72) Inventors: David A. Burgess, Menlo Park, CA (US); Shyam Kapur, Sunnyvale, CA (US)

(73) Assignee: Yahoo! Inc., Sunnyvale, CA (US)

(21) Appl. No.: 15/063,154

(22) Filed: Mar. 7, 2016

Related U.S. Application Data
(63) Continuation of application No. 11/849,986, filed on Sep. 4, 2007.

(51) Int. Cl. G06Q 30/02

(52) U.S. Cl. CPC G06Q 30/0255; G06Q 30/0277; G06Q 30/0204

(57) ABSTRACT

A method of advertising receives a data log that includes the activities of users. The users have unique identifiers and associated profiles that form a user base. The method segments the user base into user segments by types of users. Hence, a first user segment is formed. The users within the first user segment have a profile similarity. The method groups publisher inventory, and forms a first publisher group. The publishers provide content to the users. The method categorizes advertisements and thereby generates a first ad category. The advertisements relate to a marketer, which has various marketer data. The method targets a first advertisement within the first ad category based on at least one of the first ad category, the publisher grouping, and the user segments. A system for ad targeting includes a user module, a publisher module, a marketer and/or advertisement module, and a matching engine. The user module is for receiving a plurality of users and segmenting the users into user segments including a first user segment. The publisher module is for receiving several publishers' inventory and grouping the publishers' inventory into publisher groups that include a first publisher group that has a first inventory location for the presentation of advertising. The marketer-ad module is for receiving advertisements and categorizing the advertisements into ad categories that include a first ad category. The matching engine is for matching the first publisher group and/or the first user segment to the first ad category. The matching engine is also for ranking ads and placing within the first inventory location a first advertisement from the first ad category.

### RELATED APPLICATIONS

The present patent document is a continuation of U.S. patent application Ser. No. 11/849,986, filed Sep. 4, 2007, pending, which is hereby incorporated by reference.

### FIELD OF THE INVENTION

The present invention is related to the field of advertising and is more particularly directed toward targeting using historical data.

### BACKGROUND

The Internet provides a mechanism for merchants to offer a vast amount of products and services to consumers. Internet portals provide users an entrance and guide into the vast resources of the Internet. Typically, an Internet portal provides a range of search, email, news, shopping, chat, maps, finance, entertainment, and other Internet services and content. Yahoo, the assignee of the present invention, is an example of such an Internet portal.

When a user visits certain locations on the Internet (e.g., web sites), including an Internet portal, a system can capture the user's online activity. This information may be recorded and analyzed to determine patterns and interests of the user. In turn, these patterns and interests may be used to target the user to provide a more meaningful and rich experience. For example, if interests in certain products and services of the user are determined, content and advertisements, pertaining to those products and services, may be served to the user. Advertisements are usually provided by advertisers or marketers, who research and develop campaigns for the market. Content is typically provided by a network of publishers, often in conjunction with a portal provider. A system that serves well targeted advertisements benefits both the advertiser/marketer, who provides a message to a target audience, and a user who receives advertisements in areas of interest to the user. Similarly, publishers and portals are benefited by increased relevance and/or traffic. In this document, a publisher will include publisher web sites and Internet Portals.

Currently, advertising through computer networks such as the Internet is widely used along with advertising through other mediums, such as television, radio, or print. In particular, online advertising through the Internet provides a mechanism for merchants to offer advertisements for a vast amount of products and services to online users. In terms of marketing strategy, different online advertisements have different objectives depending on the user toward whom an advertisement is targeted.

Often, an advertiser will carry out an advertising campaign where a series of one or more advertisements are continually distributed over the Internet over a predetermined period of time. Advertisements in an advertising campaign are typically branding advertisements but may also include direct response or purchasing advertisements.

### BRIEF SUMMARY

A method of advertising receives a data log that includes the activities of users, the content they have visited and the advertisements they have viewed and clicked on. The users have unique identifiers and associated profiles that form a user base. The method segments the user base into user segments by types of users. Hence, a first user segment is formed. The users within the first user segment have a profile similarity. The method groups publishers, and forms a first publisher group. The publishers have several sites for providing content to the users. The method categorizes advertisements and thereby generates a first ad category. The advertisements relate to a first marketer, which has various marketer data. The method targets a first advertisement within the first ad category based on at least one of the first ad category, the publisher grouping, and the user segments.

Generally, the publisher sites include inventory for the presentation of advertisements, and the targeting step further includes selecting an advertisement, and placing the selected advertisement in a first inventory location. Preferably, the method determines an attribute value for a user action, which includes one or more of an impression, a click, a lead, and/or an acquisition. In certain cases, the attribute value involves a propensity score for the user action. The propensity is based on an advertisement and at least one of a user segment, a publisher category, and/or an advertising category. As such, the targeting is preferably based on the propensity score. Also preferably, the first advertisement includes a relevance to the user, and the targeting is based on the relevance to the user. In one implementation, targeting the first advertisement involves a first context, which includes, for instance, a predetermined web page, content, and/or a predetermined time. Further, some embodiments use an optimization algorithm to optimize a combination that includes at least two of an advertisement, a user segment, and a context. The optimizing preferably includes matching the first advertisement to the first user segment and/or matching the first advertisement to a context within the first publisher group, by using an attribute value.

In some implementations, the first ad category includes an ad campaign, and the method determines a campaign performance metric for one or more of each user segment, each publisher category, and/or each type of ad. The marketer data often includes advertisement purchase data which includes ad placement, ad targeting, and/or ad cost. The marketer data may also include advertisement performance data which includes one or more of rate of impression, click rate, lead generation rate, and/or acquisition rate. The marketer and/or advertising data is preferably for multiple forms of advertising such as graphical ads, precision match, content match and domain match type advertising, for example.

An alternative method of advertising segments users based on user information. The user information is stored in a user profile, which includes at least one of demographic information, geographic information, behavior information, and/or information that is representative of a user segment. The method groups publisher web pages based on intrinsic content within the web pages, and categorizes advertisements based on an ad campaign. The method identifies a set of attributes that relate the user segments, the publisher groups, the marketer categories, and/or the advertisements. The method determines values for each attribute. The values represent the strength of the relationships between the user segments, the publisher groups, and/or the ad categories, for a particular user activity. The method generates a hierarchical structure for the attributes based on the relationships, and targets a first advertisement by using the hierarchical structure and the attribute values.

Preferably, the user activity comprises one or more of an impression, a click, a lead, and an acquisition. The users, the publishers, the marketers, and the advertisements each have associated data that form inputs to a matching problem. For this problem, the method organizes the inputs by using the hierarchical structure and thereby advantageously reduces the problem size. The method preferably generates a hierarchical grouping of attributes further comprising: matching two or more of a user segment, a publisher group, and an ad category, thereby generating one or more hierarchical clusters; organizing the hierarchical clusters into rows; normalizing the values of an attribute within a cluster.

Preferably, the method determines a propensity score for a user action. The propensity is based on an advertisement and at least one of a user segment, a publisher category, and/or a marketer category. The method further optionally determines an average propensity by using the propensity score. Targeting the first advertisement typically involves a relevance of the first marketer category that the advertisement belongs to a first user segment and a first context. The method advantageously matches the first advertisement, by using an attribute value, to a first user segment, and/or a first publisher category.

A system for ad targeting comprises a user module, a publisher module, a marketer and/or advertisement module, and a matching engine. The user module is for receiving a plurality of users and segmenting the users into user segments including a first user segment. The publisher module is for receiving several publishers and grouping the context into publisher groups that include a first publisher group that has a first inventory location for the presentation of advertising. The marketer-ad module is for receiving advertisements and categorizing the advertisements into ad categories that include a first ad category. The matching engine is for matching the first ad category to one or more of the first publisher group and/or the first user segment. The matching engine is also for placing within the first inventory location a first advertisement from the first ad category. The matching engine can be further enhanced by ranking the advertisements in the first ad category and selecting the advertisements that improve revenue.

Preferably, the matching engine is configured to perform one or more of behavioral match, demographic match, geographic match, domain match, and/or content match. Typically, a marketer has a budget for advertising spend over a certain period of time such as per day, and the system is configured for assigning the first advertisement a cost that includes the cost of placing the first advertisement within the first inventory location. The system is optionally configured for assigning the first advertisement a weight. In some implementations, one or more of the user segments, publisher groups, and/or ad categories are sorted in a table form. Some systems further include a time component, wherein the users and the publishers are advantageously categorized by time of day. For instance, in some embodiments, the first user segment comprises users who have a higher propensity to click during particular times of day.

In some cases, multiple advertisements are linked to a single campaign. Hence, each advertisement has one or more associated attribute values wherein the attribute values associated with the multiple advertisements linked to the campaign are averaged and/or weighted for the campaign. In some cases, multiple campaigns are linked to a single advertisement, and weighting and/or averaging is performed for the attribute values of the advertisement of these cases.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a conversion funnel.

FIG. 2 illustrates a conversion funnel in further detail.

FIG. 3 illustrates a site having inventory for the placement of advertisements.

FIG. 4 illustrates a system for presenting advertisements.

FIG. 5 illustrates an exemplary categorization.

FIG. 6 illustrates an exemplary categorization in further detail.

FIG. 7 illustrates a framework for associating values.

FIG. 8 illustrates a further implementation of the framework of FIG. 7.

FIG. 9 illustrates using data in the framework of FIGS. 7 and 8.

FIG. 10 illustrates the log data of some embodiments in further detail.

FIG. 11 illustrates a system for selection and/or placement.

FIG. 12 illustrates an enhanced feature of some embodiments.

FIG. 13 illustrates a data organization process in accordance with embodiments of the invention.

FIG. 14 illustrates an advertisement selection process according to some embodiments.

FIG. 15 illustrates a test determination process of some embodiments.

FIG. 16 illustrates a verification process in accordance with some embodiments of the invention.

### DETAILED DESCRIPTION OF THE DRAWINGS AND THE PRESENTLY PREFERRED EMBODIMENTS

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

I. Introduction

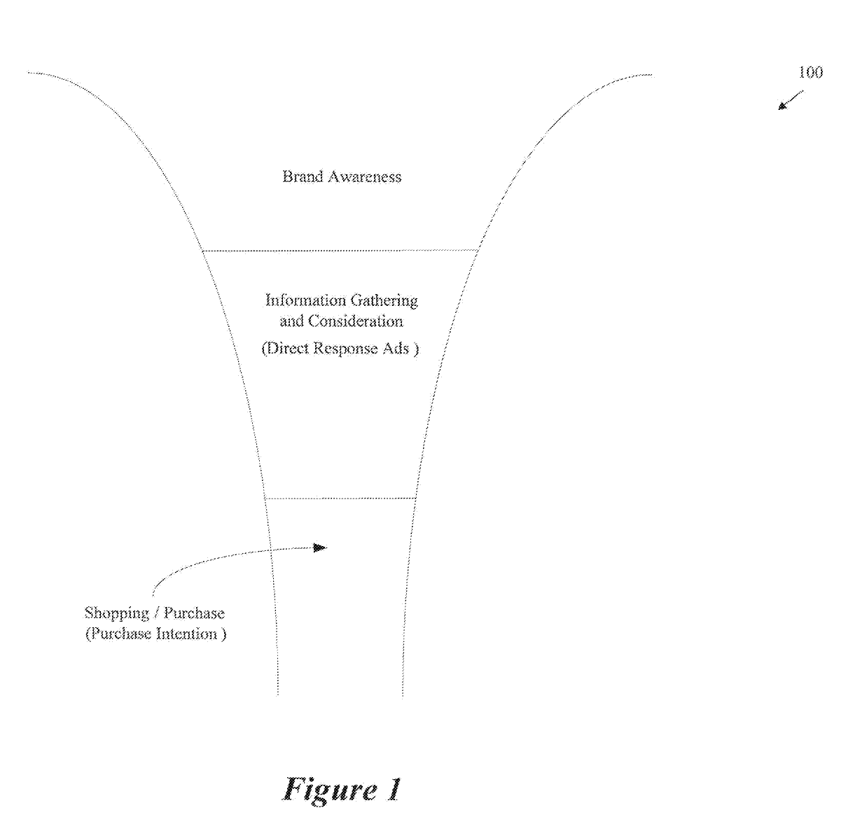

FIG. 1 illustrates a marketing funnel that identifies marketing objectives. At the top of the funnel, an advertiser may desire to acquire brand awareness for the advertiser's brand. Typically, for this type of marketing, the advertiser's goals are to promote a brand for a product by associating one or more positive images with the brand. This marketing objective may include brand advertising. In a second stage of the funnel, a user may desire to gather information for product consideration. To address this cycle of purchasers, advertisers may use direct response advertisements. There may be many different objectives associated with direct response advertising, including acquisition, retention, engagement, and monetization. The goal of acquisition is to persuade consumers to become a customer or visitor of the product or service. The goal of retention is to maintain existing customers or visitors (e.g., visitor of a web site). The goal associated with engagement is to elicit more activity in existing customers. The goal for monetization is to increase profitability of the customer via active purchase activities, such as cross-selling, as well as passive activities, such as consuming banner ads.

In direct response advertising, the overall goal is to elicit an action or response from a customer. In some instances targeting provides user profile data for direct response advertising. For example, an advertisement displayed on a web page that includes a link for the user to “click” is an example of a direct response advertisement. The last, and most focused part of the funnel, is the customer cycle of purchase intention. In this stage, the user is actively shopping, and intends to make a purchase.

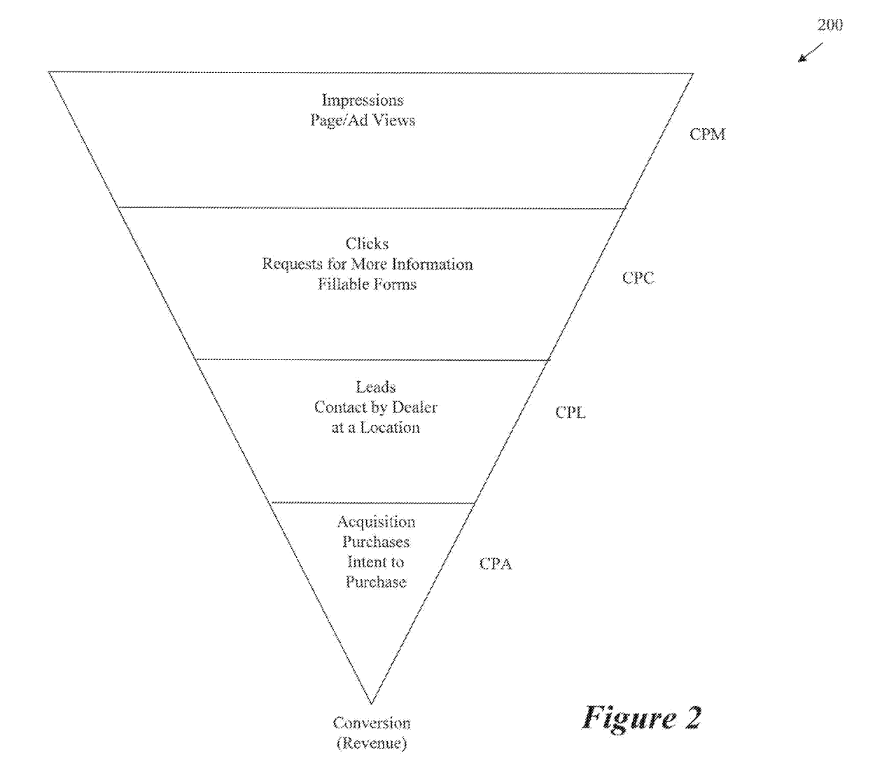

Accordingly, a company or business unit can have a variety of marketing or target objectives along a continuum of activities directed toward conversion. For example, a company may desire to attract users to a web site. Data processing that is performed for targeting may generate user profiles to acquire users to the publisher. For example, users from one business unit of the publisher or one zone of the publisher's site may be targeted to acquire users in a different business unit area or zone based on the user's profile. Similarly, the user profiles may be generated for the target objective of engaging users to visit the web site more frequently. Furthermore, the processing may generate user profiles to retain users that have previously visited the web site. FIG. 2 below is a more detailed example of objectives within a conversion funnel.

FIG. 2 illustrates a conversion funnel 200 more specifically. As shown in this figure, the funnel 200 includes several regions from broader to narrower, as a user moves from the top of the funnel 200 toward the bottom of the funnel 200. Users do not need to move through every region in the funnel and can, for example, go straight to the bottom of the funnel. For advertisements, the first region is broad and generally includes impressions of the goods or services being marketed. The next region includes more specific activity of consumerism such as clicking on an advertisement that created an impression. The next region includes indicators of higher interest such as leads. Near the culmination of the funnel 200 at its bottom are activities related to acquisition and/or purchase of the marketed goods or services. Each region involves more specific activities along a continuum of conversion until ultimately revenue is generated from an acquisition and/or purchase. Typically, there is a cost associated with the sale or marketing at each region of the funnel. Hence, there is cost per impression (CPM), a cost per click (CPC), a cost per lead (CPL), and a cost per acquisition (CPA). Typically, significant amounts of data are generated for a marketer and/or a user that relate to each of these types of activities.

The marketing goals and objectives elicit user profile data to facilitate advertisers and marketers. Some of the targeting systems disclosed herein also have application to provide user profile information to facilitate a user's online experience. In general, the goal of these systems is to match the right content, including ads, to the right user at the right time (i.e., stimulus).

Ad Targeting

Embodiments of the invention include a method of targeting an appropriate advertisement to a particular user. Preferably, the advertisement is presented to the user in the appropriate context, and preferably, at an optimized time. Historical data are advantageously used for the targeting and optimization, which improves the advertising provided by a publisher, such as Yahoo.com, and other publisher networks. Hence, particular implementations target the right advertising (what), to the right user (who), in the right context (where), at the right time (when), by optimizing an advertisement-user-context-time combination.

Particular implementations use extensive user, publisher, and marketer data that are preferably compiled from a network of resources. Some embodiments collect the data in an initial phase, while some embodiments receive data that are compiled or precompiled from external sources. These data generally include both historic and current data. For a marketer, the data include advertisement purchase information such as placement, targeting, cost, advertisement performance and conversion information. The data are preferably from multiple forms of advertising including graphical type advertisements, precision match type ads, content match type ads, and/or domain match type advertisements. For a publisher, the data include a variety of content and an array of sites, domains, pages, zones and ad inventory. For a user, the data include user profile information such as demographic, geographic, behavioral, device used, and other user type records and information. The various collected data from marketers, publishers, and/or users forms a massive targeting and/or matching problem.

Preferably, a second phase reduces the massive targeting and/or matching problem size. Particular implementations employ a form of categorization for one or more of the user base, the publisher network, and/or one or more marketers. For each category, some of these embodiments identify attributes and data values for the attributes. Hence, these embodiments further generate a hierarchical grouping of attributes.

For instance, users are advantageously categorized based on their intrinsic information, and/or on their behaviors. Typically, this information is collected at various times for storage and/or retrieval from a user profile. The profiles are often complex and include a unique identification for organization and management.

Publishers are preferably categorized based on content, such as the intrinsic content presented by web pages managed by the publisher.

Advertisements are preferably categorized based on type and/or content, on a marketer and/or on an ad campaign. In these embodiments, marketers generally develop an ad campaign that includes one or multiple advertisements for certain brands and/or products. Hence, multiple advertisements may relate to an ad campaign, and similarly, several ad campaigns may relate to one advertisement.

As mentioned above, the attributes and data values for the categories are preferably organized into hierarchical clusters. Further, associations are determined for each of the categories across the user, publisher, and/or marketer data. Some implementations construct a framework having rows to represent the associations. A particular implementation specifies the strength of the association with data values. These data values can be normalized to a scale from 0 to 100, or alternatively, from 0.0 to 1.0, or to another normalization scale.

At a third phase, embodiments of the invention use optimization algorithms to determine campaign performance metrics for each advertisement and category of advertisement with each category of user, and publisher. Advantageously, the performance of the advertisements and/or ad campaigns for the users and publishers is measured. The matching of ad categories to user segments and publisher groups improves campaign performance for marketers, improves traffic for publishers, and also improves user experience. An optional implementation further recommends optimized inventory purchases to marketers, based on the information collection and processing described above. Similarly, implementations expand inventory for particular campaigns by proposing reasonable alternatives to existing campaigns, or by directing new campaigns. Ultimately, these various optimizations and improvements further increase revenue for a publisher, the marketer and ad network that collects, manages, and processes the various data, through its sites and partners. The improvements include, for example, better ad targeting, more effective use of inventory, higher demand for inventory, which, in turn, increases inventory price.

For the marketer, advertising and spend is optimized in a number of ways. For example, embodiments provide better ad targeting and placement, more efficient purchase of inventory, and information that allows recommendations regarding creatives. Publishers also benefit from better ad targeting, more traffic, and/or revenue from non owned/operated advertising. Further, user satisfaction is improved by increasing site relevance and usefulness to the user.

B. Additional Ad Targeting Test, Experimentation, and/or Verification

Some embodiments include a method of controlled ad targeted experimentation and verification to determine and/or improve the effectiveness of advertising, and further, optimize advertising across publisher sites, zones, domains and networks. Similar to the embodiments described above, these embodiments improve ad targeting by using combinations of user, context, and/or time values. However, these embodiments perform additional steps to gather advertising performance data. For example, some implementations systematically and continuously analyze existing and new combinations to determine and/or update the efficacy and confidence in the ad-user-context optimization, thereby ensuring the quality of the recommendations.

In these cases, one or more marketers, publishers, and/or users are categorized, in a first stage. Each of these groups of categories can also be indexed in a hierarchical framework that preferably includes several data values associated with each category. At a second stage, useful combinations of each of the groups including marketers, publishers, and/or users, are identified. A statistical relevance of past performance data is calculated for each marketer, publisher, and/or user category combination. Some embodiments further calculate a margin of error.

These embodiments identify, by using a third stage, the category combinations that have no performance data or performance data with high margins of error. Some embodiments further employ a system of rules to decide combinations that have greater significance or value, to the system. Then, in a fourth stage, the identified category combinations are tested to improve the quality and breadth of the performance data.

Alternatively, test combinations are selected based on other criteria. For instance, new creatives, hard-to-find inventory, different targeting options, and other combinations are selected, for which performance data are more particularly gathered. These cases use the performance data to empirically determine the conversion efficacy of various combinations. Further, as mentioned above, the performance data of these test cases are further used in conjunction with optimization algorithms to match advertisements to users and to publishers, which improves both campaign performance and user experience. Marketers are further benefited by receiving recommendations for inventory purchases, or by suggestions to expand inventory for particular campaigns. Ultimately, quality and value are optimized for marketers, while traffic and revenue are optimized for the publisher web pages.

II. Advertising Optimization

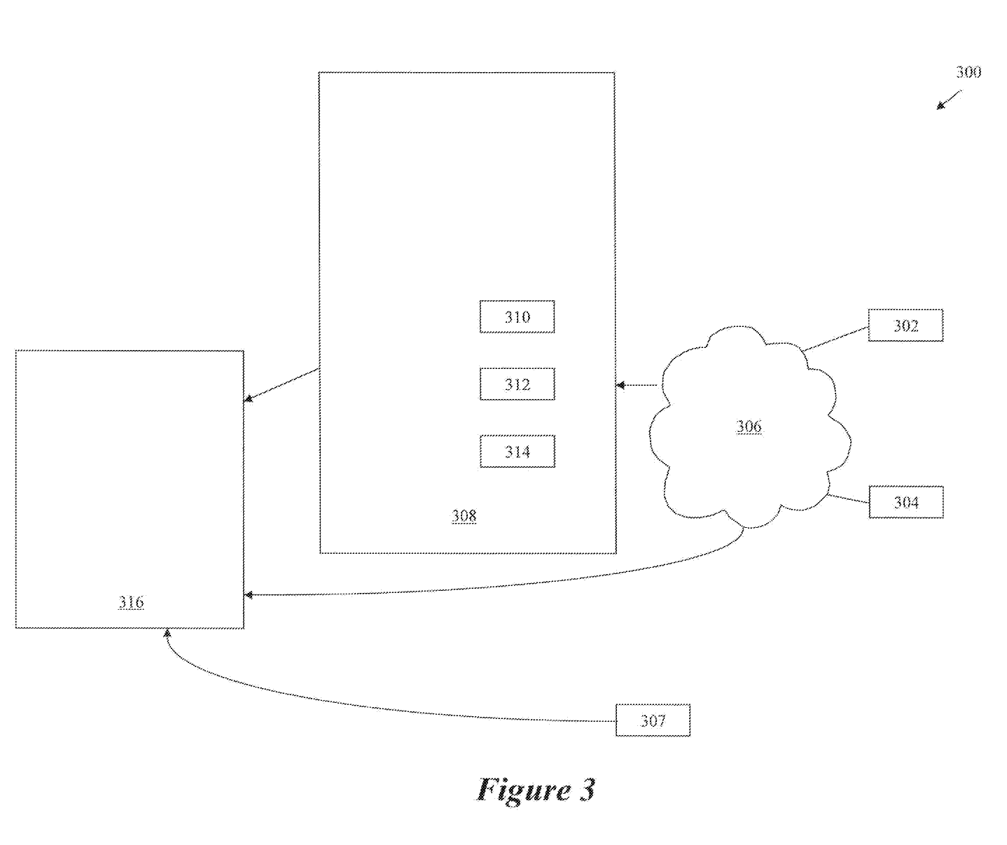

FIG. 3 illustrates a system 300 that presents advertising to users through a network. As shown in this figure, the system 300 includes a plurality of users 302 and 304 that interact with a network 306. The network includes local area networks, wide area networks, and networks of networks such as the Internet, for example. The network 306 typically includes several sites comprising a number of web pages having content and inventory. The ad inventory is for the presentation of advertising to the users 302 and 304. Accordingly, the network 306 is coupled to an exemplary site or page 308 that includes several inventory placements 310, 312 and 314. The site 308 is coupled to a server 316 for data collection and processing. The server 316 receives data from a variety of sources, including directly from the users 302 and 304, from the network 306, from the site 308, and/or from another source 307. Typically, the site 308 is provided by a publisher, while the server 316 is typically provided by an ad network. Further, as users 302 and 304 interact with the network 306, and the site 308, advertisements placed in the inventory of the site 308, are presented to the users 302 and 304.

The selection and/or presentation of advertising through the inventory is a non trivial process. The inventory is typically distributed across many varied sites, zones, domains and pages. There are many different users and types of users, and marketers, advertisements, and ad campaigns are usually numerous and varied as well. Timely, relevant, appropriate and/or coherent matching and delivery of content such as advertising is a problem that can have millions of input data points, or more.

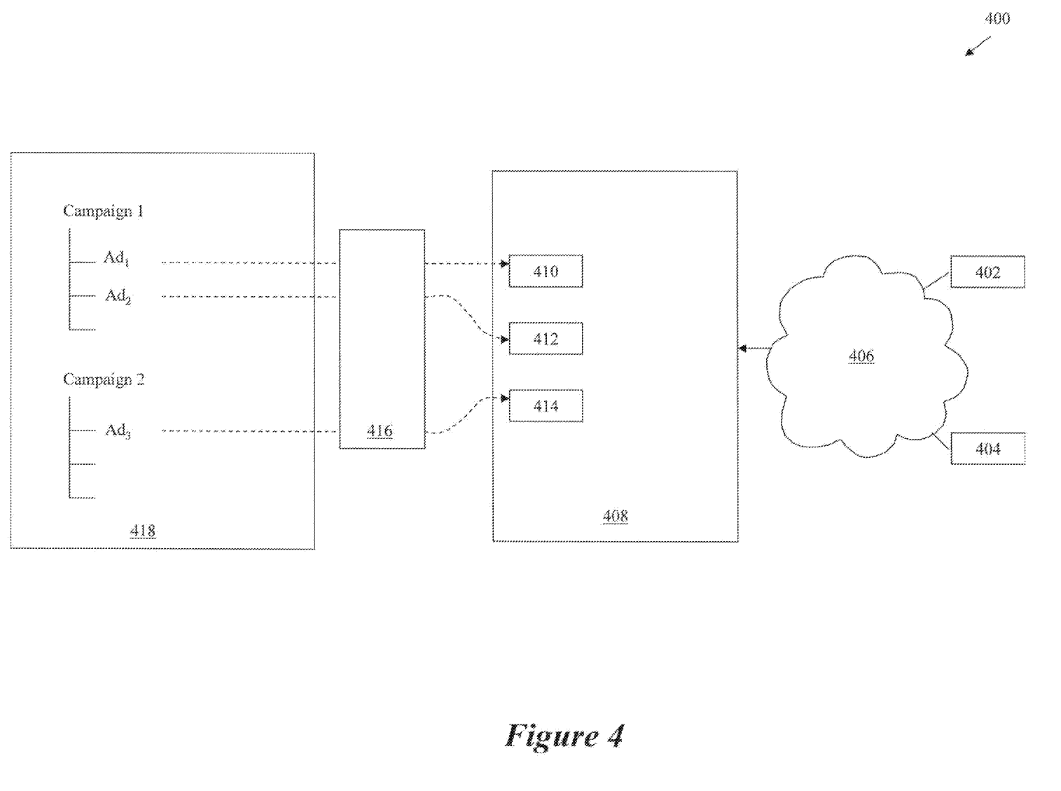

Hence, FIG. 4 illustrates a system 400 for the intelligent selection of advertising for the site 408, and the presentation of the selected advertisements to the users 402 and 404 through a network 406. As shown in this figure, the system 400, includes a server 416 coupled to the site 408, and a marketer 418 that provides information to the server 416. The marketer 418 generally has one or more ad campaigns that have one or more advertisements. A campaign and advertisements within the campaign are designed to promote an activity toward conversion by the user such as, for example, to generate a user impression, to generate a click, a lead, and/or an acquisition. Some of these activities are described above in relation to FIG. 2. Accordingly, the server 416 selects and/or places the advertisements from the various campaigns of the marketer 418 with the inventory 410, 412, and 414, of the site 408. Preferably, the selection is based on a variety of data that is collected and/or received by the server 416. The data includes user data, publisher data, and/or marketer data that is compiled, processed, and stored in certain advantageous ways.

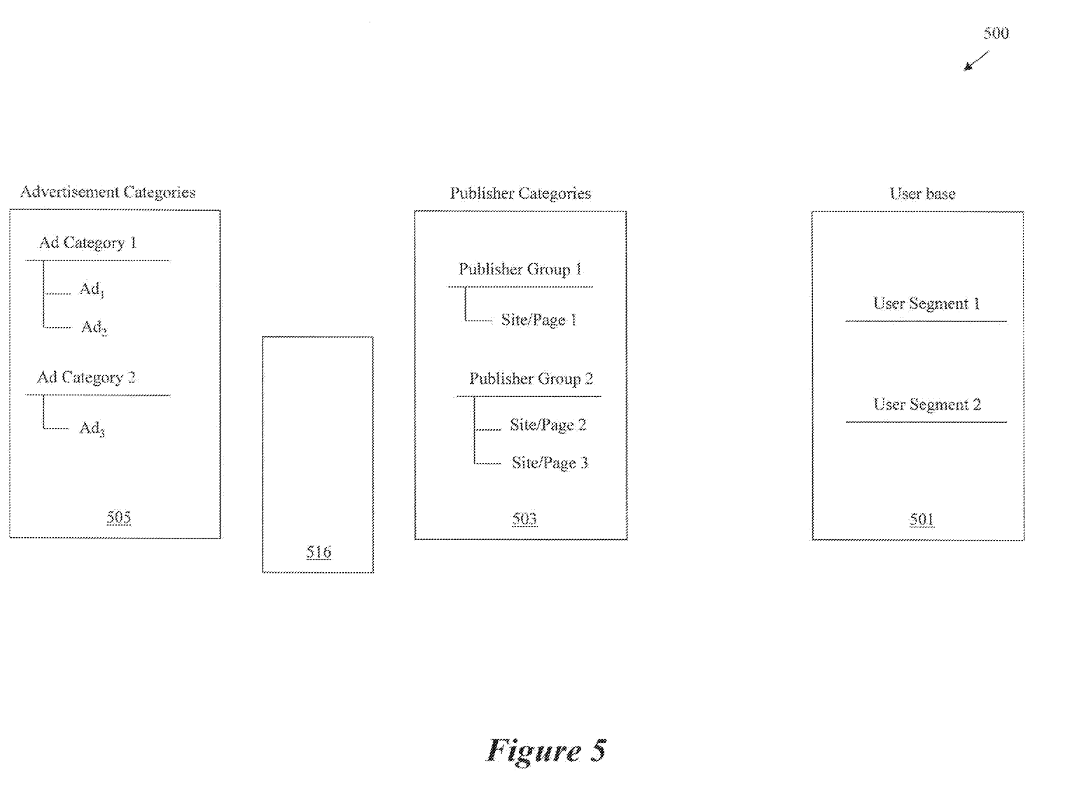

More specifically, FIG. 5 illustrates a system 500 for the data compilation and/or processing of some embodiments. As shown in this figure, the system 500 includes data from a user base 501, data from one or more publishers 503, and data from one or more marketers 505. Advantageously, the system 500 groups, organizes and/or categorizes the data of each type.

For instance, the user base is divided into user segments based on data for each user within the user base. The data for each user are typically stored within a user profile that has a unique reference identifier, and a variety of information about the user such as demographic, geographic, behavioral, and other user information, for example. For instance, one user segment might include females, about 30 years of age, with above average income, located near or within a metropolitan area, that show an affinity for cats, and who may be shopping for cars such as by frequenting car buying sites. As evidenced above, the user segmentation of some embodiments has variable granularity, from broad demographic divisions, to more specific finer distinctions between users.

Publishers usually provide sites, zones, domains and/or pages having content and inventory. The system 500 organizes the publishers and the available inventory, by using the content of each site or page. Examples of publisher sites and/or content include news sites, and car buying sites. As mentioned above, in relation to the user segments, the groupings of some embodiments are optionally broad and coarse grained, or are alternatively fine grained. For instance, the groupings for car buying includes a group for sites that provide guidance or advice regarding buying cars, in addition to a group for performing car purchase and acquisition, and sites for the purchase of specific car accessories.

Similarly, the system 500 organizes the data for marketers in various ways. For instance, advertisements and/or campaigns are categorized based on type or nature of the advertisement. Examples of advertisements and/or campaigns include advertisements for cat food, or alternatively ads for cars, or for car accessories. Generally, the more detailed, finer grained, and/or closely tuned the ad categories, the publisher groups, and the user segments, the better the targeting performance of the system. However, finer grain data processing generally comes with a tradeoff cost, as the number of data points increases. Some embodiments, balance the performance of the system with the costs of fine grain data processing.

In FIG. 5, an exemplary organization is illustrated for each data type including user segment 1, user segment 2, publisher group 1, publisher group 2, ad category 1, and ad category 2. However, one of ordinary skill recognizes that the data organizations are likely to include larger numbers of user segments, more publisher groups, and/or additional ad categories.

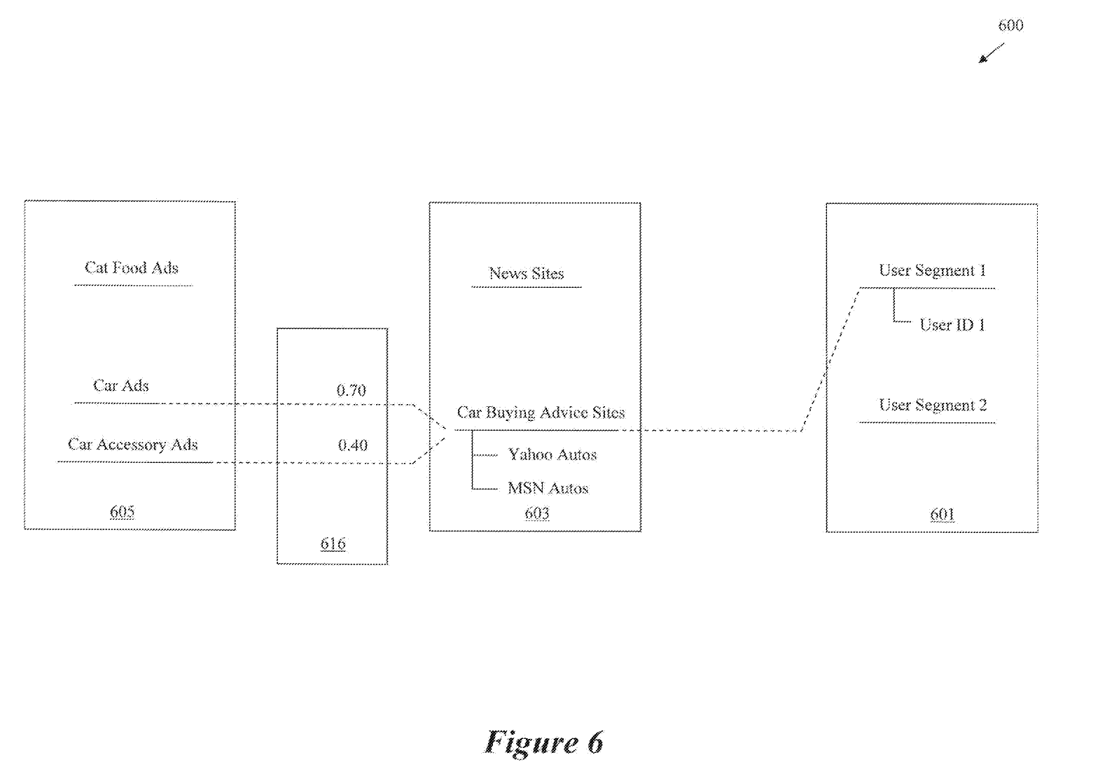

FIG. 6 illustrates some exemplary categorizations for the various data of FIG. 5. As shown in this figure, the sample ad categories 605 include a category for cars and another category for car accessories. One of ordinary skill recognizes that there are many different ad and/or marketer categories, and further recognizes that many different types of advertisements are contemplated for each category. The publisher groups 503 include a group of car buying advice sites and/or pages such as, for example, Yahoo Autos, MSN Autos, Edmunds, Kelley, and the like.

The user base 601 includes user segment 1, which has a user who is logged or tracked by a unique identifier UserID1. Also shown in FIG. 6, some embodiments advantageously determine a relationship between the user segment 1, and the publisher groups, such as the car buying advice sites, and/or the marketer categories, such as the car and car accessory categories. Preferably, the relationships are measured, tracked, stored, and/or updated empirically in relation to each other, and are further preferably normalized to a convenient scale. In a particular implementation, the relationship measured includes propensity. For instance, when a user associated with UserID1 visits a particular publisher site such as Yahoo Autos, then the UserID1 propensity for the Yahoo Autos site is determined. In this case, however, the UserID1 who visits the Yahoo Autos site has a complex set of possible interactions with one or more marketer categories and/or ads that are selectively presented by using the inventory therein. For instance, regarding the relationship for propensity, the propensity measure optionally relates to any combination of activities illustrated in FIG. 2. More specifically, the relationship measure is for one or more of impressions, clicks, leads, and/or acquisitions. When the propensity to click is measured, for example, an average propensity to click is advantageously determined to obtain a click through rate (CTR). Click through rates are known in the field to have a variety of beneficial uses.

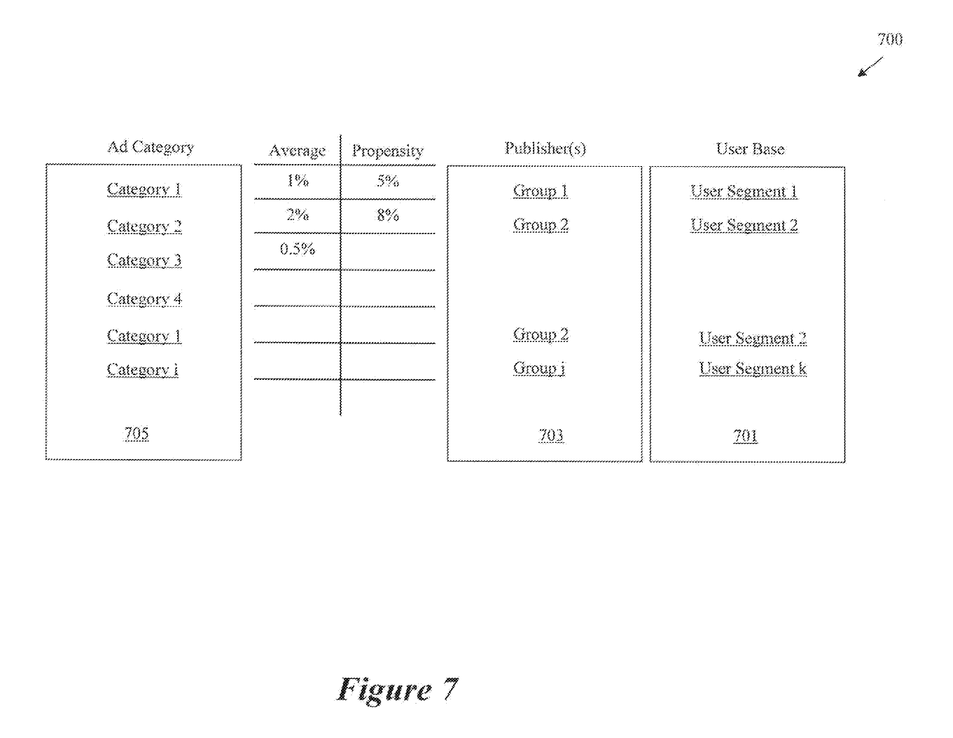

FIG. 7 illustrates an implementation that stores the relationships between user segments, publisher groups, and/or marketer and ad categories by using a tabular format. Each relationship is based on several complex factors. For instance, the user segmentation1 is usually based on a set of commonalities and/or differences between users and user segments. The publisher content sites, zones, domains and/or pages are similarly grouped in various ways. Hence, the relationship of a user segment and/or a publisher group, separately or in combination, to a marketer or ad category is based on one or more of a user to user difference, a user to publisher group interaction, a publisher group to group difference, a publisher group to marketer category interaction, and/or a user segment to marketer category interaction. The measures such as for propensity and/or average are calculated in a number of ways based on these interactions. FIG. 7 illustrates exemplary values for propensity and average that relate the user base and/or publisher groups, to the marketer categories. As mentioned above, these values optionally relate to one or more of the activities of FIG. 2, such as propensity to click, and click rate, for example. In one implementation, the propensity is calculated by determining the affinity, for example click through rate, of a user from a user segment, to an ad or to an ad category, with the strength of the relationship between a publisher site and the ad or the ad category. As mentioned above, the affinity is measured by the propensity to click, or to generate a click, or by using another factor.

The relevance and/or propensity of the advertisement is preferably calculated for several and/or all combinations of ad category, publisher group, and user segment. For instance, as illustrated by example in FIG. 7, the propensity (of 5%, for example) for the combination of Ad Category1, Publisher Group1, and User Segment1, is determined along with other combinations such as the combination including Ad Category2, Publisher Group2, and User Segment 2, and further, the combination including Ad Category1, Publisher Group2, and User Segment2. One of ordinary skill recognizes that these examples are merely representative of many possible combinations for Ad Categories, Publisher Groups, and/or User Segments, and the illustrated values are also merely representative of the many relevance and/or propensity scores for each respective combination. This concept is generalized in FIG. 7, and the subsequent figures, by the exemplary index variables i, j, and k, respectively for the Ad Categoryi, the Publisher Groupj, and the User Segmentk, wherein the exemplary variables generally indicate any possible combination.

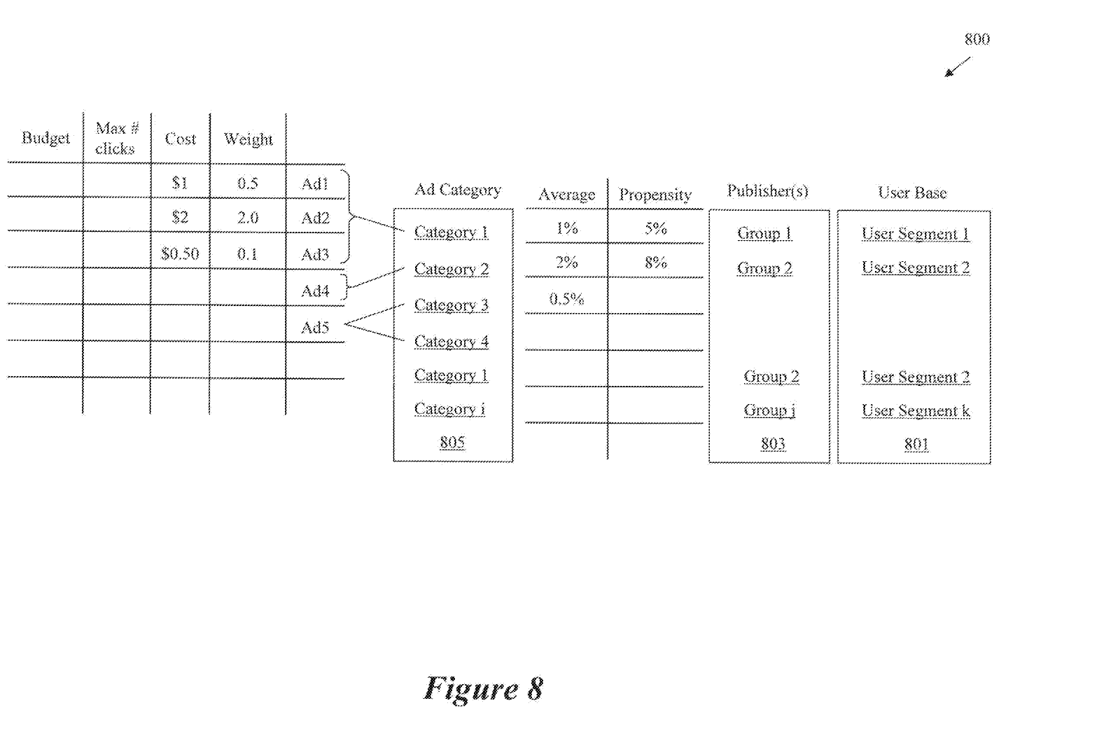

FIG. 8 illustrates embodiments of the invention that include further complex information. As shown in this figure, advertisements and ad categories have complex relationships. More specifically, Ad1, Ad2, and Ad3 relate to Category1. Meanwhile Category2 relates to Ad4, and Ad5 relates to both Category3 and Category4. When multiple advertisements relate to a single category, and/or when multiple categories relate to a single advertisement, some embodiments factor the complex relationships by averaging the values for each advertisement within a category, and/or for each category related to a single advertisement. Alternatively, some embodiments employ a system of weighting to account for the complex relationships. Further, each advertisement and/or ad category is selectively associated with additional data including a maximum budget for the category, the advertisement, and/or the activity, a maximum number of activity events, and/or a cost per event. For instance, the weight of Ad2 within Category1 is 2.0, the cost per event such as clicking is $2 per event. Hence, for a marketer budget of $2000, the marketer may purchase 1000 clicks relating to the Ad2.

Preferably, the relationships are determined and/or the associations are generated by using an offline or batch process. Some embodiments use an extensive set of data in the form of web activity logs that are obtained from user activity in relation to a set of publisher sites, zones, domains and pages.

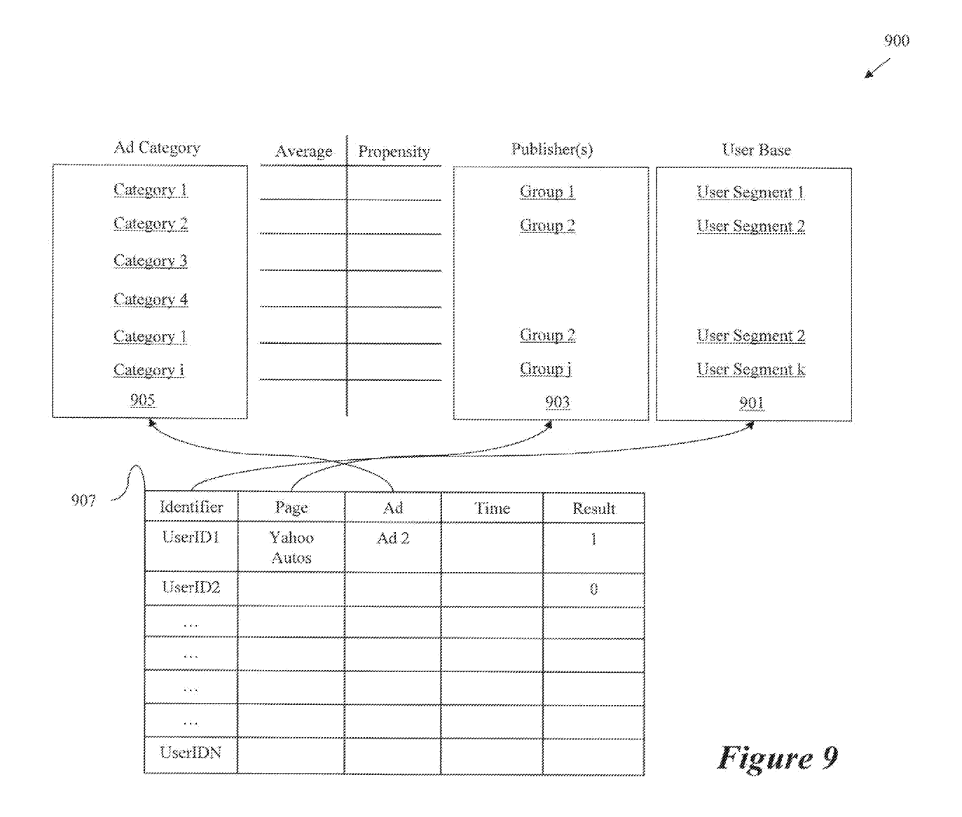

FIG. 9 illustrates the data of some embodiments being advantageously used. As shown in this figure, the data 907 includes fields for a user identifier, a page, an ad, a time, and a result. Hence, from the fields it is advantageously determined whether and/or when a specific user performed a specific activity relating to a specific ad on a specific page at a specific time. If the activity comprises clicking on Ad2 on the Yahoo Autos site, then the result is “1” and a time is optionally used. As further shown in FIG. 9, some embodiments advantageously parse the data 907 along with additional data (such as geographic, demographic ad behavior data) for use by each of the user base 901, the publisher groups 903, and/or the marketer/ad categories 905. These data are then advantageously used in determining the relationships, and/or building the associations described above.

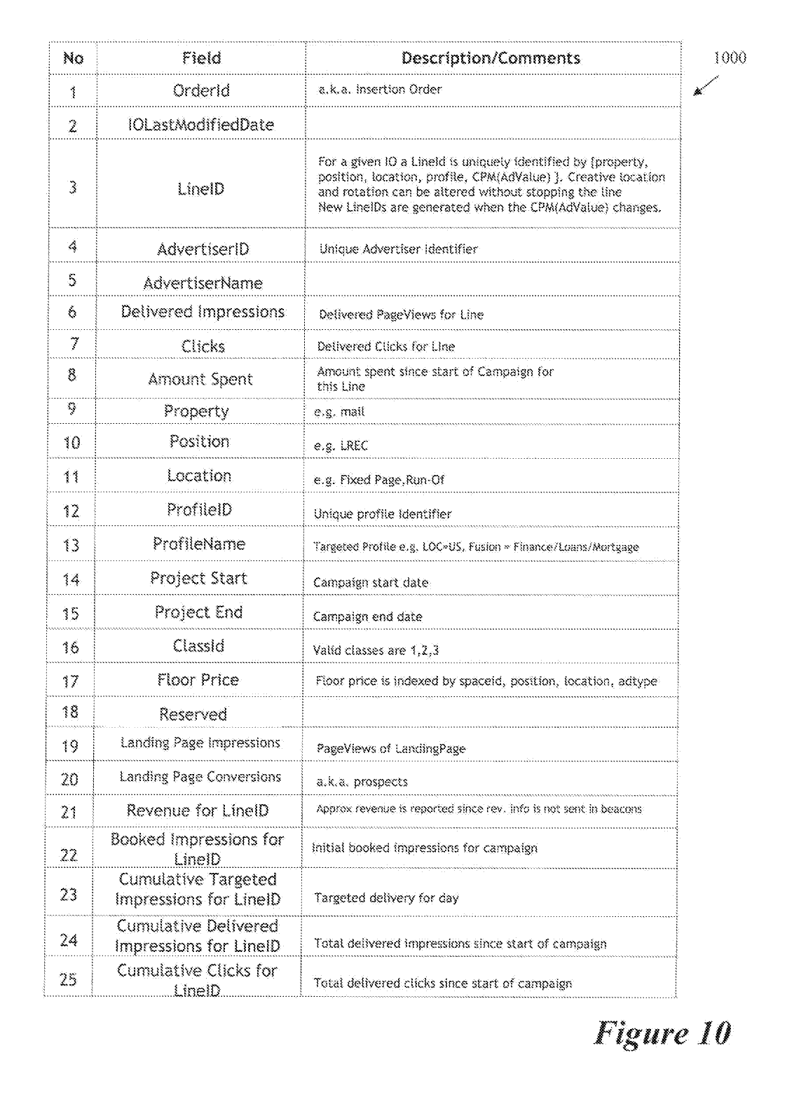

FIG. 10 illustrates the fields of the log data of some embodiments in further detail. As shown in this figure, the log data of an implementation includes a number of fields such as fields for data sources, advertiser/marketer identification, numbers of impressions, clicks, conversions, and a variety of other data for use by the embodiments described above. The data collection and/or tabulation further include additional metrics for the monitoring and analysis of performance such as, for example, cumulative counts and pricing information. Once the relationships are determined, some embodiments apply the calculations as users visit various publisher groups to select ads.

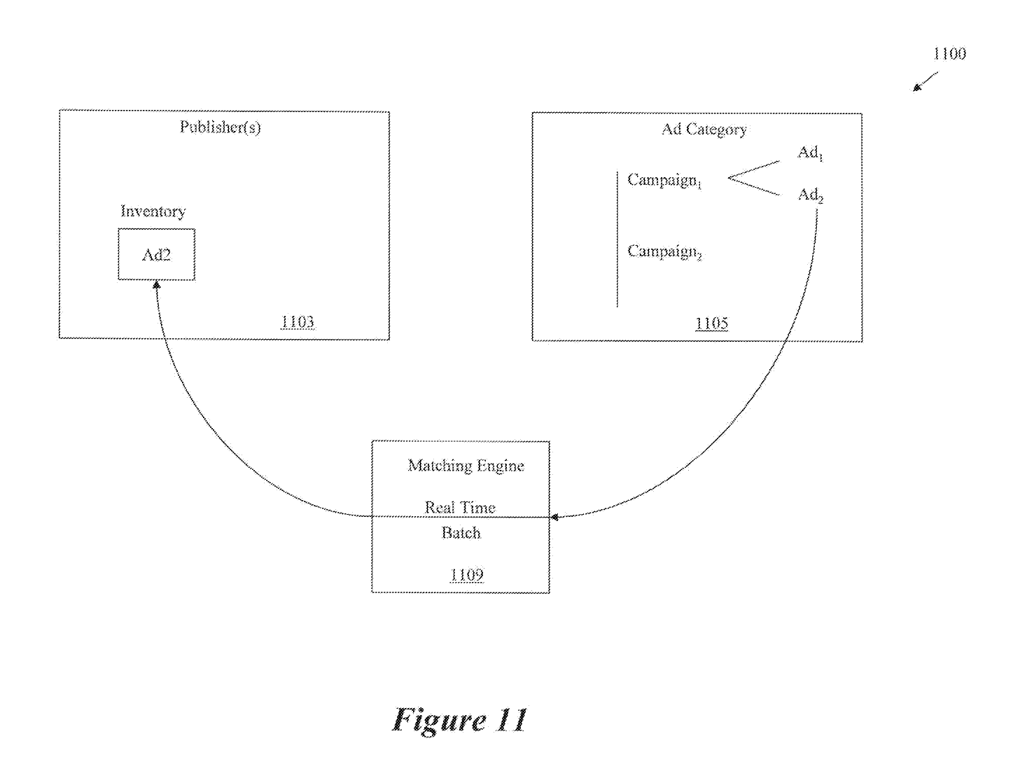

FIG. 11 illustrates a publisher site 1103 having inventory, and a marketer 1105 having advertisements for selection and/or placement with the inventory. Preferably, the selection and/or placement are performed by a matching engine 1109. In particular implementations, the relationship determinations, the value calculations, and/or the associations described above are performed in conjunction with the matching engine 1109, by using an offline or batch process. Then, when the foregoing framework is constructed, and the associations and associated values are populated and/or optimized, the matching engine 1109 is advantageously configured to select and place advertisements with the inventory on the fly, on a real time basis, and/or as needed such as, for example, when users visit and navigate publisher sites, pages, and other locations where inventory is present.

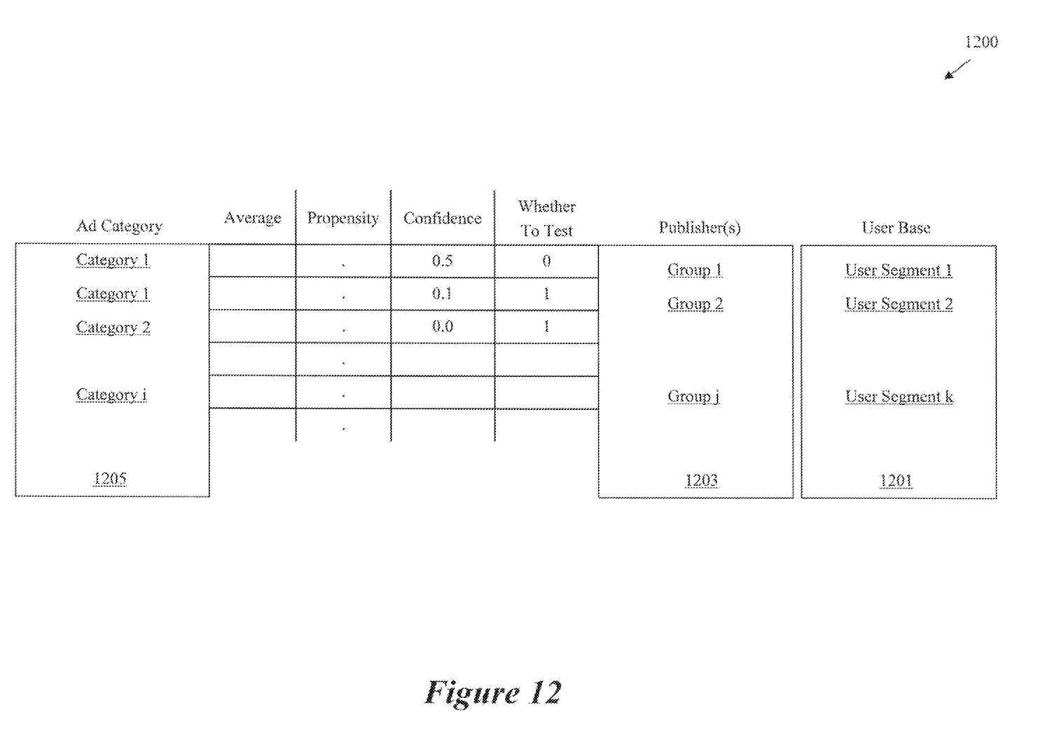

FIG. 12 illustrates that some embodiments include enhancement features. For instance, an implementation 1200 includes confidence data and/or an indicator whether to test a combination or a value associated with a combination for reliability. The indicator may be a binary number that is based on whether the confidence data exceeds a threshold for reliability. The confidence data preferably includes values that are normalized to a convenient scale, and that measure the reliability of the relationship values, such as propensity. As described above, the propensity is optionally relevant to one or more of the activities of FIG. 2 such as, for example, impressions, clicks, leads, and/or acquisitions.

The embodiments described above typically operate by using imperfect or incomplete data. Stated differently, some calculations and/or populated values are determined by using more input data, while other calculations are undesirably based on less input data. Hence, the reliability and/or accuracy vary for the values expressing the different relationships. Accordingly, some embodiments identify relationship values having lower confidence, and test the underlying relationship to adjust the relationship value and thereby adjust the confidence in the determined relationship and its calculated value. In FIG. 12 for instance, an exemplary combination of Ad Category1, Publisher Group1, and User Segment1 has an associated propensity value that has a confidence of 0.5. In this case, it has been determined that the confidence in the propensity value is sufficiently high such that verification or adjustment of the propensity and/or confidence values is not needed. However, FIG. 12 illustrates additional combinations having lower exemplary confidence values that are determined to benefit from obtaining additional input data. These input data are advantageously obtained by presenting sampling iterations of the test combination to users and recording the result of the interaction such as the user activity. In one implementation, if the result of the test case is near the propensity value for the combination, then the confidence in the propensity increases. If the result of one or multiple test cases differs significantly from the propensity value, then the confidence decreases.

In the embodiments where test cases are performed, each of the test cases generally has a cost in terms of lost revenue, as the performance of the ad campaign will be suboptimal. In these cases, data are gathered for the system. Hence, embodiments of the invention only selectively assemble and perform certain test cases, to minimize the cost of this type of system optimization. Some embodiments further apply a set of rules to decide whether to test existing combinations and/or novel combinations, in this type of system value verification and/or optimization. For instance, certain combinations are known and/or predetermined to have lesser value to marketers, publishers, and/or users. Such combinations are generally expected to produce little result, and/or a well-established result that generally does not warrant the use of system resources.

One example is presenting a user segment that has an age range below 15 years of age in the state of California with an advertisement and/or campaign that is designed to elicit an acquisition response for luxury automobiles. It is typically suboptimal to employ system resources to select and place ads of this nature, to this user segment, within any publisher group context. Moreover, it is undesirable to test cases such as these. Accordingly, some embodiments employ rules to forego inefficient combinations and/or testing. These rules are optionally complex. For instance, instead it may be highly useful to test the efficacy of presenting 16 year olds an advertisement that is designed to elicit an impression regarding a particular car manufacturer. The campaign, advertisement, or creative may be further cobranded with a particular consumption good such as a soft drink, or another product, that has immediate synergy for conversion in either of the brands or categories.

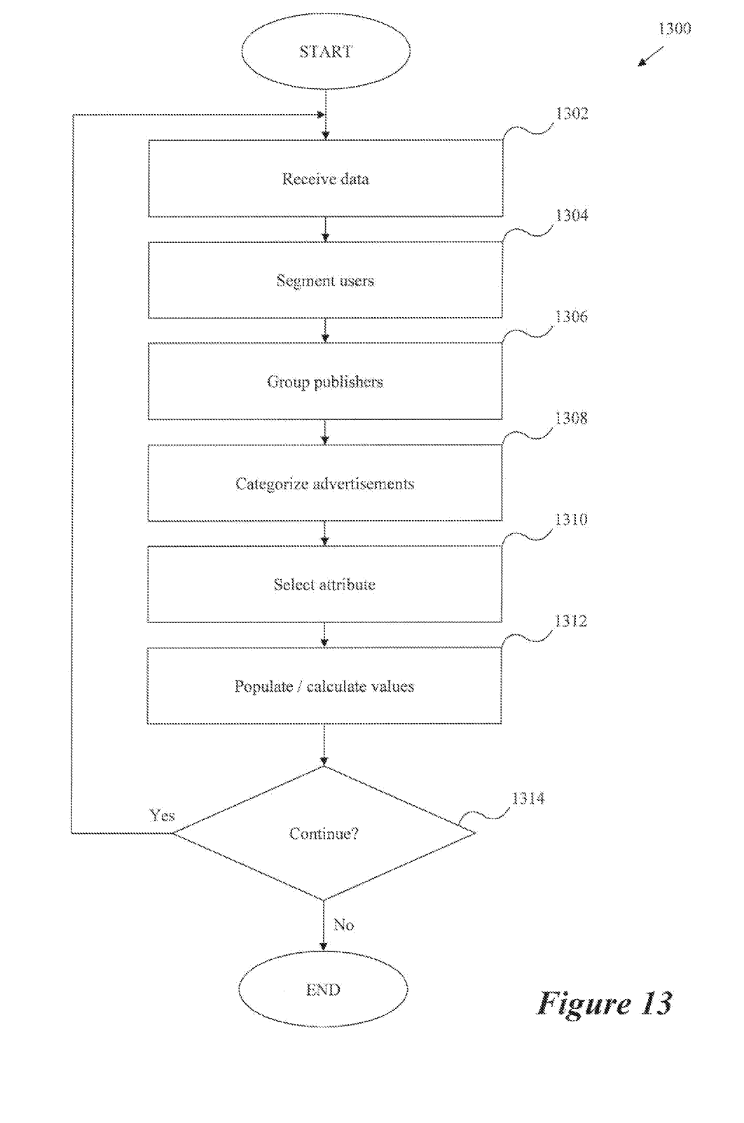

FIG. 13 illustrates a data organization process 1300 in accordance with an embodiment of the invention. As shown in this figure, the process 1300 begins at the step 1302, where data are received. Preferably, the data are received from a variety of sources, and may be precompiled. For instance, in some embodiments the data include web logs that record the transactions and activities of several users, at a plurality of publisher sites. The data may further include specific information regarding each user and/or publisher such as, for example, demographic, geographic, and/or behavioral information about the users, and/or context and inventory information about the publishers. Some embodiments also collect information regarding marketers, advertisements, campaigns, and/or user interactions with the foregoing and with publisher inventories.

Once data are collected at the step 1302, the process 1300 transitions to the step 1304, where users are segmented. The users are preferably segmented from a user base into user segments by using the data collection described above. Then, at the step 1306, the process 1300 groups the publishers. The groupings are typically based on the publisher content and/or inventory description. At the step 1308, advertisements are categorized. The categorization is based optionally on the nature or type of advertising, on the marketer, and/or on the campaign. Some embodiments create the segments, groups and categories concurrently or iteratively. After or while user segmentation, publisher grouping, and/or advertisement categorization are preformed, the process 1300, at the step 1310, selects an attribute to monitor and/or analyze. The attribute preferably involves one or more conversion activities such as those described above in relation to FIG. 2. Once an attribute and/or activity are selected, the process 1300 determines the values that are known or available for the attribute, and populates the available values in a particular format. Many values are advantageously available through the data collection of step 1302. Some embodiments populate the values into a tabular framework for organizing and identifying various combinations of data from users, publishers, and/or marketers in relation to the selected attribute and activities of conversion. When the known values are populated, additional calculations are performed regarding averages, rates, and other aggregate values for a user segment, a publisher group, and/or a marketer ad category in the framework.

Then, the process 1300 transitions to the step 1314, where a determination is made whether to continue, such as part of batch and/or a real time process, for example. If the determination is made to continue, then the process 1300 returns to the step 1302. Otherwise, the process 1300 concludes.

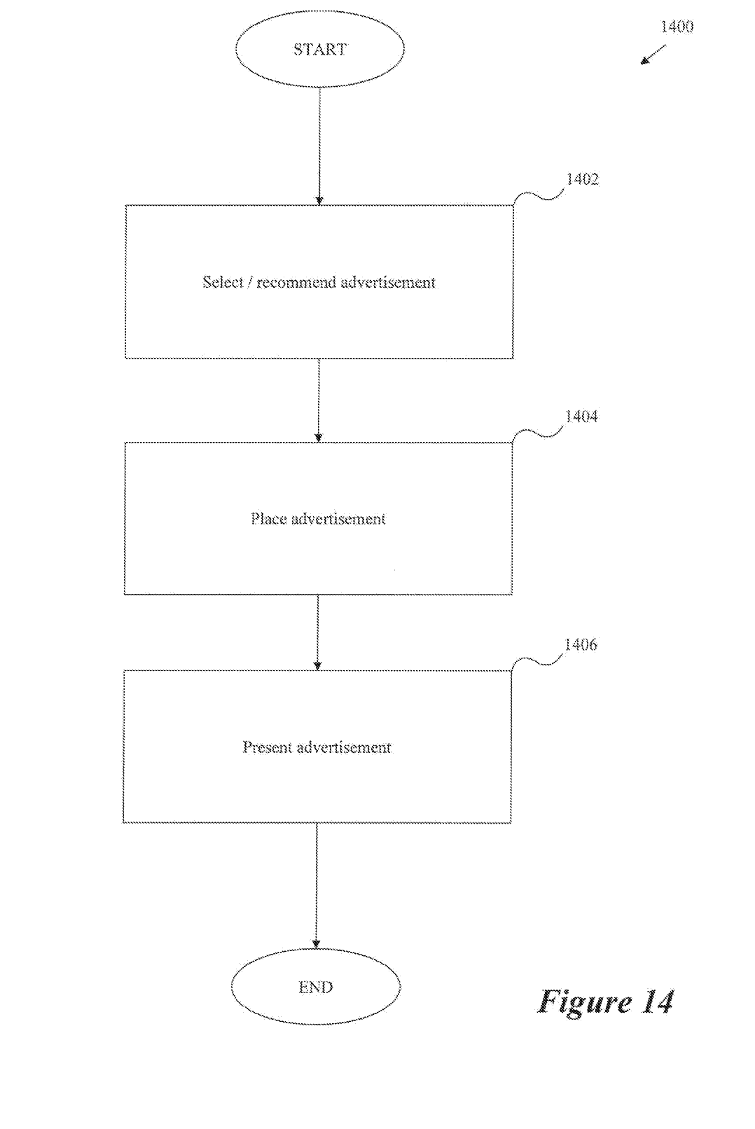

FIG. 14 illustrates an advertisement selection process 1400 according to some embodiments. As shown in this figure, the process 1400 begins at the step 1402, where a particular advertisement is selected and/or recommended. The selection is preferably based on the data collection and framework construction described above. For instance, a user from a particular user segment visits a publisher site that contains car buying advice. The publisher site contains content and inventory for the presentation of advertisements to the user. The process 1400 preferably selects an advertisement or campaign from a set of predetermined categories. The selection is based on a set of available, known or calculated, values regarding the user, the publisher and/or the marketer, thereby forming a certain optimized combination.

Once a selection or recommendation is determined at the step 1402, the process 1400 transitions to the step 1404 where the selected or recommended advertisement is placed. Preferably, the placement is within the inventory of the publisher site, near an optimized location for the user's attention. Some embodiments place one or more advertisements from a particular category or campaign within the publisher site's inventory in real time, as the user navigates the publisher's site pages. Some embodiments place advertisements based on timing such as time of day, independently and/or in conjunction with demographic, geographic, and other data.

When the selected advertisement is placed, the process 1400 transitions to the step 1406, where the placement and advertisement is presented to the user. The advertisement is typically in the form of a creative designed to elicit a response from the user, such as a conversion-type activity. Some embodiments further monitor or record the user's activities and/or response to the presentation at the step 1406. These collected data may be incorporated into further targeting determinations and calculations, or may be included in the user's profile information. Then, the process 1400 concludes. In some other embodiments placement and presentation of the ad occur at the same time.

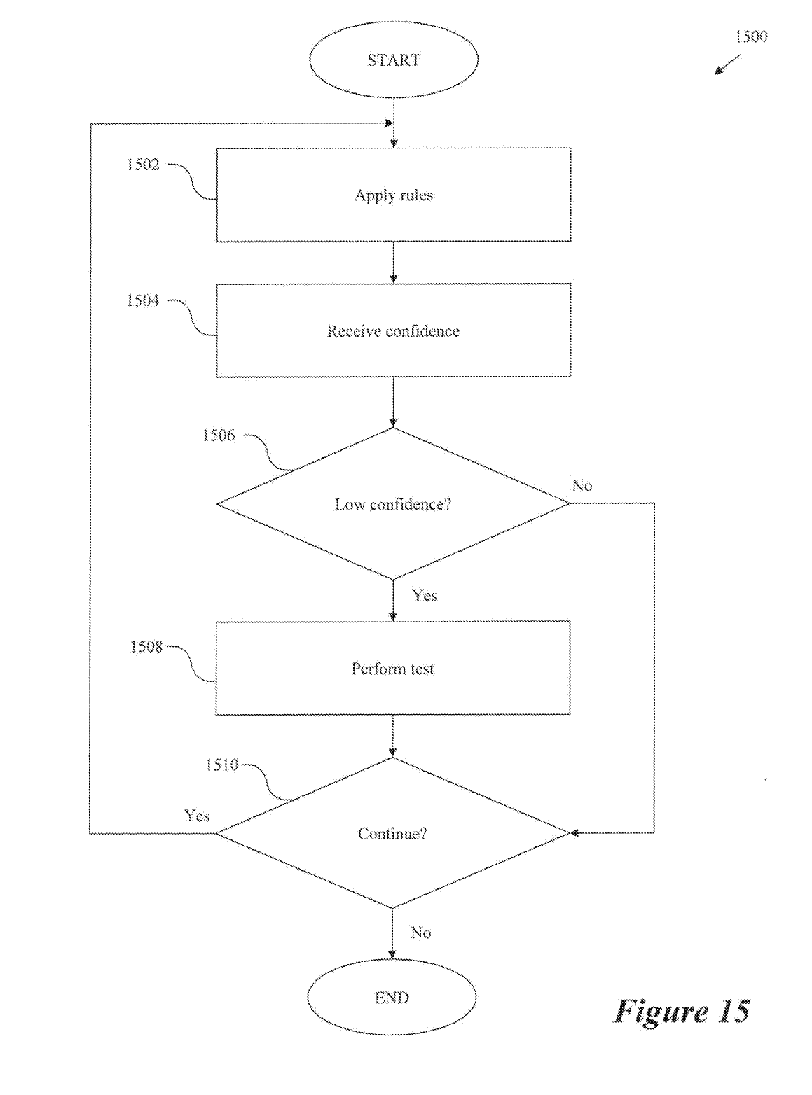

FIG. 15 illustrates a test determination process 1500 of some embodiments. As shown in this figure, the process 1500 begins at the step 1502, where a set of rules are optionally applied. The rules preferably filter a set of undesirable combinations, and retain and/or highlight a set of more desirable combinations. The combinations relate a user or user segment to a publisher group, and/or to a marketer's advertisements and ad categories. The filtering is based on a variety of factors such as, for example, the likelihood of the combination, the likelihood of a conversion arising from the combination, the practicality to one or more of the user, the publisher context, and/or the marketer, or another factor.

After the rule(s) are applied at the step 1502, the process 1500 transitions to the step 1504, where a confidence level is received. The confidence level is an indicator of the reliability of a value measuring a relationship within a system. Preferably, the relationship value measures a propensity of a user from a particular user segment and within a particular publisher context to perform a desired action for a particular marketer or ad campaign category. The action preferably involves conversion type activities such as, impresssions, clicks, leads, and/or acquisitions, for example. The relationship value further optionally includes affinity measures, and other collected data concerning the user, a publisher, and the campaign(s) of a marketer. Stated differently, the relationship value indicates the probability of an event based on these input data.

At the step 1506, it is determined whether the confidence level is below a predetermined threshold. If at the step 1506, the confidence is above the threshold, then the process 1500 transitions to the step 1510, and forgoes the testing at the step 1508, which is deemed of lesser benefit.

If the confidence level is lower than the threshold, then the process 1500 transitions to the step 1508, where a test is performed. The test checks the value of the relationship such as the propensity. The test is performed a variety of different ways, and for different numbers of iterations depending on the underlying relationship being verified. For instance, where the relationship activity being tested comprises impressions, the test may include iterations in the range of 10,000 to 20,000 impressions. When the activity comprises clicks, the testing may involve 2,000 to 3,000 clicks. Data collected during the testing and/or iterations are advantageously used. For instance, if the propensity values of each test or iteration do not change significantly during the testing, then the confidence in this value and combination in the system increases. If the propensity values do change significantly during the testing, then the confidence in these values decreases. Additional steps are then optionally performed such as, for example, to reduce use by the system of the unreliable combination, removal or modification of the combination, and/or additional testing of the combination and its associated data values.

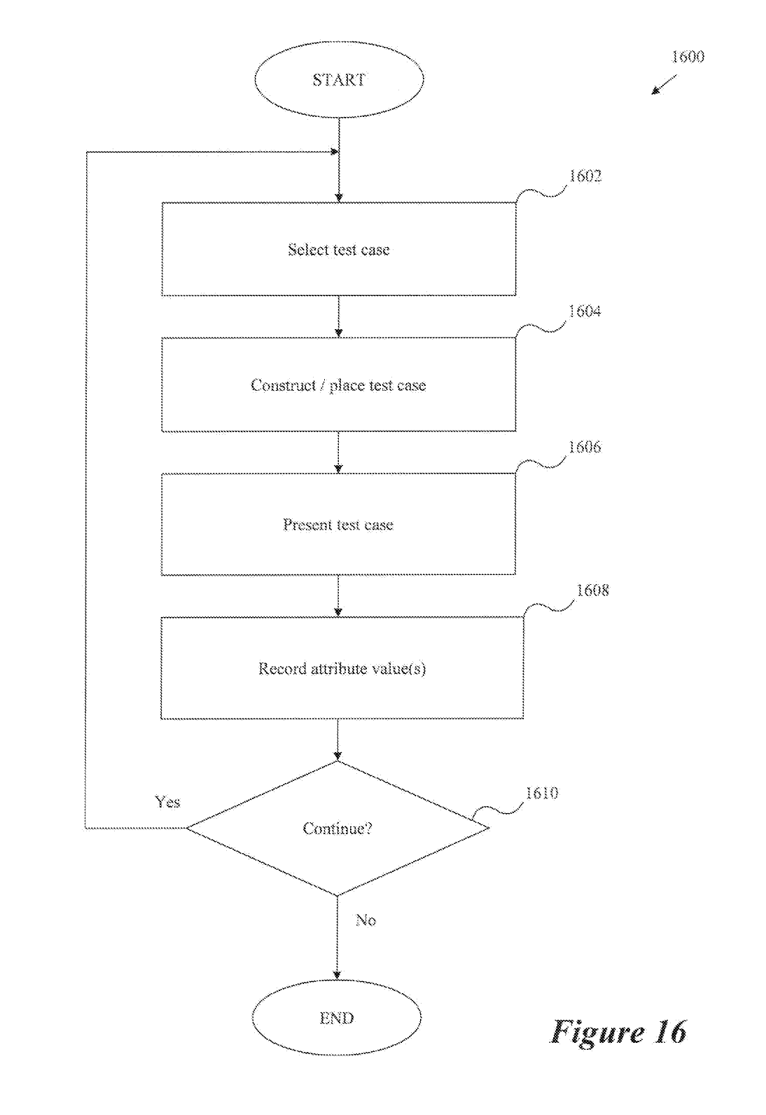

After the testing is performed, the process 1500 transitions to the step 1510, where a determination is made whether to continue. If the process 1500 should continue, then the process 1500 returns to the step 1502. Otherwise, the process 1500 concludes. FIG. 16 illustrates a verification process 1600 of some embodiments. Some embodiments perform the verification process 1600 for low confidence combinations and/or propensity values in conjunction with the testing at the step 1508, of the FIG. 15. As shown in FIG. 16, the process 1600 begins at the step 1602, where a test case is selected. The test case optionally includes a combination having a low confidence value as indicated above, or involves a new combination for which little data are available, or another combination of particular interest to a user segment, a publisher group, and/or a marketer or ad campaign category.

Once the test case is selected, the process 1600 transitions to the step 1604, where the test case is assembled and/or placed at a location within the inventory for a particular user segment. Since inventory is used for the purpose of data collection, rather than optimal revenue generation/conversion, some embodiments use care in the selection and/or placement of the test case. Further, some embodiments use a set of rules to filter less important test cases and/or identify more important cases.

After the placement, the process 1600 transitions to the step 1606, where the selected test case is presented for a particular publisher group and/or for a particular user segment. As mentioned above, the selection and placement are tuned accordingly, and optionally include such factors as demographic, geographic, behavioral, time, or other data. Then, the process 1600 transitions to the step 1608, where attribute value(s) are recorded for the test case. Such values include, for example, impressions, clicks, leads, acquisitions, rates, propensities, and/or other behaviors, activities and metrics. The data are advantageously stored and/or used to determine the reliability and performance of the test case, such as the efficacy of the combination, for example. After the data are collected, the process transitions to the step 1610, where a determination is made whether to continue. If the process 1600 should repeat, then the process 1600 returns to the step 1602. Otherwise, the process 1600 concludes.

III. Summary and Advantages

Embodiments of the invention select and/or place advertisements within particular inventory locations. The selection is preferably based on an advantageous combination of the advertisement, a user, a context, and/or a time. The selected combination improves marketer's advertising, improves publisher's (non owned and operated) advertising, improves advertiser network revenue and/or improves a user satisfaction or experience when visiting a publisher site. For instance, the selected combination preferably achieves better ad targeting, which results in more effective use of inventory such as, for example, by better advertisement placement and/or more efficient purchase of inventory. Improved targeting further increases demand for inventory and/or inventory price.

In a specific example, “revenue-order” banner advertisements are advantageously improved. In the search context, revenue ordering is performed to optimize revenue per search. Banner ad displays are preferably targeted and/or optimized for targeting, and especially for direct marketing ads. In these implementations, advertisements are categorized along a number of dimensions. The “best possible” banner ads are selected and presented for each user browse and/or context. Once performance of advertisements improves, the price charged for advertising increases.

Some embodiments improve campaigns for marketers such as by recommending creatives for campaigns. Particular implementations optimize advertising campaigns for marketers who may wish to place advertisements on publisher sites across the Internet. These implementations are advantageously used for many different kinds of advertising such as search, banner, CPA/CPL, and other types of advertisements. Generally, more revenue is generated from the improvements.

A. Data

Preferably, extensive data are used from a network or resources. Hence the data include large amounts of user, publisher, and/or marketer data. These large input data sets are typically difficult to manage. However, preferred embodiments reduce the massive numbers of inputs into organized data sets. These embodiments further apply optimization algorithms to determine and/or select particularly efficacious combinations from among the data sets, including user, publisher, and/or marketer data sets. Further some embodiments optionally use iterative testing and/or verification techniques to improve the selected combinations and ensure the confidence in their efficacy.

The data advantageously include historic and/or current data, for a variety of events, and for one or more of the marketer, publisher, and/or user data sets. Preferably, the data are for all forms of advertising including graphical ads, precision match, content match, domain match, and other advertising.

For the marketer and/or publisher, the historic and current data often include advertisement performance and purchase information such as placement, targeting, and cost, for example. Marketers typically have fine-grained campaign goals. To address these goals, embodiments of the invention initially use high-level categories such as branding and direct response categories to identify sets of company, industry, and/or sub-industry categories. Some embodiments might use Dun and Bradstreet codes and/or SIC codes, in the identification of categories. Categories are further advantageously based on creative types, or advertisement types, or other attributes. Creative types include text advertisements, banner ads, video ads, and/or landing page type advertisements. Creative attributes include ad size, primary image, and other attributes.

Publisher data preferably includes contextual attributes such as, for example, the web site context or nature, keywords searched, content of the web page, position and/or placement of ads, within the content and/or within the context.

User data includes demographic type attributes, geographic location information, behavioral attributes of a users or a group of users, and/or system attributes. Demographic attributes might include age, gender, and tenure, while system attributes might include browser information, and connection speed, and geographic attributes involve address targeting, by using IP, MAC, or another type of addressing, and user behavioral attributes involves user interests, categories, affinities, and other behavioral data.

B. Reduce Problem Size

Some of the implementations described above collect a large amount of granular data relating to many different attributes for each type of data set. Advantageously, embodiments of the inventions aggregate these data into increasingly manageable sets, and further organize the data within a framework having rows of data values. In a particular step, hierarchical groupings of attributes are identified. One implementation segments users based on the user data, groups publishers based on site, zone, domain or page content, and/or categorizes advertisements based on advertisement, marketer, and/or ad campaign. This implementation then organizes the different data sets into hierarchical clusters of rows, calculates a set of values associated with each set, and identifies particularly useful combinations of data sets.

C. Optimization

Once the data are organized into sets and preferably into a framework for identifying selected combinations, some embodiments determine campaign performance metrics for each type of advertisement for each user segment and/or for each publisher group. Moreover, these embodiments advantageously match advertisements within the marketer data set to particular users and/or publishers. The matching is optimized for efficacy to a particular result such as, for example, impressions, clicks, leads, acquisitions, ad/campaign/marketer performance, and/or another conversion activity. Accordingly, implementations of the invention preferably increase revenue in relation to costs and provide other benefits for marketers, and/or publishers, while providing improved user experience. More specifically, particularly beneficial inventory purchases are recommended to marketers, and/or suggestions based on empirical data are provided to expand inventory for particular campaigns.

D. Additional Optimization, Testing, and Verification

Some embodiments continuously run carefully selected test cases to gather data systematically. These embodiments ensure the efficacy and confidence in the selected combinations, which assists the optimization system in making recommendations regarding targeting, delivery, placement, timing, selecting creatives, and other recommendations. Test cases are preferably designed to sample new creatives, hard-to-find inventory, different targeting options, and the like, to empirically measure the performance of these test cases.

These and other implementations provide additional features such as marketer analytics in the form of cost per lead or cost per action metrics, recommendations for advertising sales, and for sales operations. The marketer analytics and metrics are advantageously used to establish benchmark practices and generate industry reports such as for the on-line advertising industry. As described above, some implementations use a phased approach. In a first phase, existing or historical data are analyzed to obtain insights. In a second phase, a system or framework is constructed by using the historical data. In a third phase, selective determinations are performed by using specific test cases. Moreover, implementations optionally perform error checking by systematically comparing recommendations made by the optimizations described above with external recommendations such as those made by experts. This verification further improves the performance of the system and/or framework.

While the invention has been described with reference to numerous specific details, one of ordinary skill in the art will recognize that the invention can be embodied in other specific forms without departing from the spirit of the invention. For instance, the examples given above often relate to online media. However, targeting across a multiple of media types is applicable as well. Thus, one of ordinary skill in the art would understand that the invention is not to be limited by the foregoing illustrative details, but rather is to be defined by the appended claims.

1. A method for matching advertisements with users and publishers in an online system, the method comprising:
at a computer,
receiving user data recording user interactions by a plurality of users with web page content provided by publishers and with advertisements on web pages viewed by the users, the user data organized in part in association with respective user identifiers uniquely identifying respective users;
using the user data, identifying commonalities and differences among the users;
using the user data, segmenting the plurality of users into a plurality of user segments based on the commonalities and the differences so that respective users of each respective user segment of the plurality of user segments have commonalities which permit common processing of the respective users of the each respective user segment;
using the user data, identifying commonalities and differences among the advertisements on the web pages viewed by the users;
using the user data, categorizing the advertisements into a plurality of advertisement categories according to the commonalities and the differences among the advertisements so that respective advertisements of each respective advertisement category have commonalities which permit common processing of the respective advertisements of the each respective advertisement category;
using the user data, identifying commonalities and differences among publishers having content on the web pages viewed by the users;
using the user data, categorizing the publishers into a plurality of publisher categories according to the commonalities and the differences among the publishers so that respective publishers of each respective publisher category have commonalities which permit common processing of the respective publishers of the each respective publisher category;
reducing size of a matching problem to match advertisements with publishers and with users by:
matching at least two of:
a user segment of the plurality of user segments;
a publisher category of the plurality of publisher categories; and
an advertisement category of the plurality of advertisement categories;
generating a hierarchical data structure having one or more hierarchical clusters;
organizing the one or more hierarchical clusters into rows of data stored in a memory by the computer; and
normalizing values of an attribute within a hierarchical cluster;
using the user data, calculating a plurality of propensity scores for one or more user actions, each respective propensity score indicating a probability that a user in a respective user segment of the plurality of user segments, will take a user action of the one or more user actions within a respective advertisement category of the plurality of advertisement categories or within a respective publisher category of the plurality of publisher categories;
subsequently, receiving at a computer a request for an advertisement to be placed on a particular web page including content of a publisher and to be viewed by a particular user;
selecting, using a propensity score of the plurality of propensity scores and values of the attribute in the hierarchical data structure, a particular advertisement of the plurality of advertisements for display to the particular user on the particular web page; and
communicating the selected particular advertisement for display on the particular web page to the particular user.

2. The method of claim 1 wherein identifying commonalities and differences among the users comprises identifying common demographic, geographic and behavioral information about the users.

3. The method of claim 2 wherein segmenting the plurality of users into a plurality of user segments placing users having common demographic, geographic and behavioral information together in a respective user segment.

4. The method of claim 1 wherein identifying commonalities and differences among publishers comprises identifying common content of each web page page on which the publisher has content.

5. The method of claim 1 wherein categorizing the advertisements into a plurality of advertisement categories comprises organizing the advertisements based on type or nature of each respective advertisement.

6. The method of claim 1 wherein categorizing the advertisements into a plurality of advertisement categories comprises organizing the advertisements based on a subject of each respective advertisement.

7. The method of claim 1 wherein categorizing the advertisements into a plurality of advertisement categories comprises organizing the advertisements based on an advertised product or an advertised service of each respective advertisement.

8. The method of claim 1 wherein calculating a plurality of propensity scores for one or more user actions comprises calculating propensity scores for one or more of impressions, clicks, leads, or acquisitions.

9. The method of claim 1 further comprising:
calculating a confidence score for the each respective propensity score as a measure of whether the user data includes a sufficient amount of user data to reliably generate the each propensity score of the plurality of propensity scores.

10. The method of claim 1 wherein generating a hierarchical data structure comprises:
identifying one or more attributes among the user data;
identifying hierarchical groupings among the identified attributes; and
generating the hierarchical data structure using the hierarchical groupings.

11. The method of claim 1 further comprising matching a first advertisement to a first respective user segment by using the values of the attribute.

12. The method claim 11 further comprising matching the first advertisement to inventory within a first respective publisher category by using the values of the attribute.

13. The method of claim 1 wherein selecting the particular advertisement is done in substantially real time, as the request for an advertisement to be placed on a particular web page is received, following an offline or batch process performed using the user data to generate the hierarchical data structure and determine the plurality of propensity scores and values of the attribute in the hierarchical data structure to thereby reduce processing time and memory requirements when selecting the particular advertisement.

14. A data processing system comprising:
memory configured to store user data which records user interactions by a plurality of users with web page content provided by publishers and with advertisements on web pages viewed by the users, the user data organized in part in association with respective user identifiers uniquely identifying respective users;
a matching engine implemented by a processor in conjunction with the memory, the matching engine configured to solve a matching problem to match an advertisement with a user requesting a web page including content of a publisher, the matching engine further configured to reduce size of the matching problem and thereby reduce data storage requirements of the memory and processing requirements of the processor by:
in an offline or batch process,
segmenting the plurality of users into a plurality of user segments based on commonalities and differences among the users;
categorizing the advertisements into a plurality of advertisement categories according to commonalities and differences among the advertisements;
categorizing the publishers into a plurality of publisher categories according to commonalities and differences among the publishers;
matching at least two of:
a user segment of the plurality of user segments;
a publisher category of the plurality of publisher categories; and
an advertisement category of the plurality of advertisement categories;
in the memory, generating a hierarchical data structure having one or more hierarchical clusters organized into rows of data stored in the memory; and
calculating a plurality of propensity scores for one or more user actions including an impression, a click, a lead or an acquisition;
subsequently, in near real time, making use of the hierarchical data structure stored in the memory by the offline or batch process,
receiving at the matching engine a request for an advertisement to be placed on a particular web page including content of a publisher and to be viewed by a particular user;
selecting, using a propensity score of the plurality of propensity scores and values of the attribute in the hierarchical data structure, a particular advertisement of the plurality of advertisements for display to the particular user on the particular web page; and
communicating the selected particular advertisement for display on the particular web page to the particular user.

15. The data processing system of claim 14 wherein the matching engine is operative to identify commonalities and differences among respective users, respective advertisements, and respective publishers of the user data and to group the plurality of users, the advertisements and the publishers using the commonalities and differences.

16. The data processing system of claim 14 wherein the matching engine is configured to select the particular advertisement by matching an advertisement of the plurality of advertisements to a respective publisher category by using values of the attribute.

17. The data processing system of claim 14 wherein the matching engine is configured to select the particular advertisement by matching an advertisement of the plurality of advertisements to a respective user segment by using values of the attribute.

18. The data processing system of claim 14 wherein the matching engine is configured to:
calculate a confidence score for the each respective propensity score as a measure of whether the user data includes a sufficient amount of user data to reliably generate the each propensity score of the plurality of propensity scores.

19. The data processing system of claim 14 wherein the matching engine is configured to:
identify propensity scores having relatively low confidence scores; and
generate additional user data to improve the confidence scores.

20. The data processing system of claim 19 wherein the matching engine is configured to
generate a test case directed to the low propensity score;
present sampling iterations of the test case to users;
record results of the presented sampling iterations as additional user data; and
compare the additional user data with a propensity value for the test case.
